(19) United States
(12) Patent Application Publication
(10) Pub. No.: US 2022/0237484 A1
(43) Pub. Date: Jul. 28, 2022

(54) FORECASTING TECHNOLOGY PHASE USING UNSUPERVISED CLUSTERING WITH WARDLEY MAPS

(71) Applicant: EMC IP Holding Company LLC, Hopkinton, MA (US)

(72) Inventors: Mohamed Abouzeid, Hopkinton, MA (US); Amr Abdel Aziz, Hopkinton, MA (US); Abdul Rahman Diaa, Hopkinton, MA (US); Marianne Toma, Hopkinton, MA (US); Mohamed Elsawy, Hopkinton, MA (US); Seif Helal, Hopkinton, MA (US); Stephen J. Todd, North Andover, MA (US); Osama Taha Mohamed, Hopkinton, MA (US); Yaseen Moussa, Hopkinton, MA (US)

(21) Appl. No.: 17/160,782

(22) Filed: Jan. 28, 2021

(51) Int. Cl. G06N 5/04; G06N 20/00

(52) U.S. Cl. CPC G06N 5/04; G06N 20/00

(57) ABSTRACT

One example method includes identifying datasets known to contain data relating to different technologies, extracting the data from the data sources, performing preprocessing on the data, clustering the data after the data has been preprocessed, and the clustering comprises generating data clusters, and mapping each of the data clusters to a phase of a Wardley Map. The mapping may be used to make a prediction about which phase a particular technology would fall under in a future time period.

### FIELD OF THE INVENTION

Embodiments of the present invention generally relate to generating forecasts based on one or more datasets. More particularly, at least some embodiments of the invention relate to systems, hardware, software, computer-readable media, and methods for forecasting technology phases using unsupervised data clustering in conjunction with Wardley maps.

### BACKGROUND

Technology companies, among others, are interested in determining where various technologies are in their lifecycle. For example, some technologies may be in an early phase and thus relatively undeveloped, while other technologies may be in a late phase and thus unlikely to undergo further significant advancements, and yet other technologies may be positioned between an early phase and a late phase. Being able to determine where a technology is positioned in terms of its lifecycle may provide an enterprise with insights such as where to concentrate resources, and where new opportunities may exist. However, while attempts have been made to make such determinations, a variety of problems has arisen.

One of such problems concerns system complexity. That is, the subset of technologies that will be the basis for lifecycle phase determinations. These technologies are abstractions of a much bigger and multifaceted set of interactions in the real world. For example, if “artificial intelligence” is one of the technologies in question, this really refers to the general public and private sector efforts in developing and using this technology. Since this scope is very broad, the model that should be best used for this system of technologies becomes much more complex to theorize and implement. This is a fundamental limitation to the scientific approach to model systems.

Another issue that surfaces is the unavailability of ground truth information that could be used for verification of the effectiveness of the model. Since these technologies do not manifest themselves in a finite number of observations, one cannot objectively and effectively find ground truth to drive the model. This issue makes it very hard to fine-tune and verify the correctness of the model.

Another problem that has arisen concerns data scarcity. As noted above, the system of technologies in question, (and other complex systems similar in nature), is broad and multifaceted. Finding data that describes this complexity, good enough to create a model based on, is a challenge. In many cases, the inability to obtain the necessary data may stop the modeling efforts early on as there would be no use in creating a model that captures irrelevant/insufficient information. The problem becomes even more difficult when trying to use open-source data, as such open-source data typically has a structure, availability, and amount, that are variable.

Further, whether or not data is open-source, there remains the challenge of data correspondence. In short, it is very difficult to get curated data that fits the constraints and objective of the modeling process. Usually, the data would belong to a certain scope that may be related to the objective, but not solely related to that objective. Other feature data could be of great value to the modeling effort. This raises the issue of finding a correspondence between the features to determine the best features to use for the modeling.

A final example of a problem that has arisen in conjunction with attempts to generate technology lifecycle phase forecasts concerns model bias. Ideally, the aim may be to find a model that explains the system with as little bias as possible. This bias can be in the form of a data assumption, for example, that the data being modeled is normally distributed, or an assumption about the nature of the system. In the case of technology forecasting, it is very difficult to construct a model that either has correct assumptions/bias, or none. The difficulty stems from the fact that the system, again, is very complex in its structure, and therefore is very hard to fit into a single model. It is not necessary that the system is modeled using strictly one unique model, but even finding a hybrid model that works better still poses a challenge.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses a 4-phase Wardley Map.

FIG. 2 discloses an example system design.

FIG. 3 discloses an application of the Elbow method.

FIG. 4 discloses example clusters of data features.

FIG. 5 discloses another application of the Elbow method.

FIG. 6 discloses an application of K-Means clustering with 4 clusters.

FIG. 7 discloses the implementation of the outcome of a clustering process.

FIGS. 8.1, 8.2, 8.3, and 8.4, disclose respective cluster divisions.

FIG. 9 discloses various K-Means clusters.

FIGS. 10.1, 10.2, 10.3, 10.4, and 10.5, disclose respective cluster divisions.

FIG. 11 discloses Affinity Propagation clustering.

FIG. 12 discloses an example method.

FIG. 13 discloses an example computing entity configured and operable to perform any of the claimed methods and processes.

### DETAILED DESCRIPTION OF SOME EXAMPLE EMBODIMENTS

Embodiments of the present invention generally relate to generating forecasts based on one or more datasets. More particularly, at least some embodiments of the invention relate to systems, hardware, software, computer-readable media, and methods for forecasting technology phases using unsupervised data clustering in conjunction with Wardley maps.

In general, example embodiments of the invention may operate to predict the future status of technologies through a data-driven methodology that uses a hybrid of models in conjunction with open-source data. Unsupervised clustering algorithms may be used, in correspondence with a Wardley Mapping technique, to estimate the current conceptual status of specified technologies. This model may then be used to make predictions about the future of these technologies.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that the current phase of a technology, relative to the lifecycle of that technology, may be determined. In an embodiment, predictions may be made as to when a technology may enter future phases in its lifecycle. In an embodiment, the use of open-source data may provide good results in terms of forecasting. In an embodiment, forecasts generated by embodiments of the invention may enable better decisions as to, for example, enterprise resource allocation, product development efforts and opportunities, and intellectual property protection strategies.

It is noted that embodiments of the invention, whether claimed or not, cannot be performed, practically or otherwise, in the mind of a human. In connection with the illustrative examples disclosed herein, embodiments of the invention are applicable to, and find practical usage in, environments in which large databases, such as the Google Patents and IEEE databases, are analyzed to obtain and extract data of interest concerning particular technologies. Such analysis and extraction, and the subsequent processing of the extracted data, are well beyond the mental capabilities of any human to perform practically, or otherwise. Accordingly, nothing herein should be construed as teaching or suggesting that any aspect of any embodiment of the invention could or would be performed, practically or otherwise, in the mind of a human.

### A. Overview of Some Example Embodiments

In the rapidly-changing technology and innovation world, there is a persistent need to prepare for the circumstances of the future. One way to achieve this, following the scientific and mathematical discourse, is to create models that attempt at explaining the current system, and then extrapolate, based on that model, predictions about the future of the system.

This process can be rigorous, and therefore starts with defining the scope. Embodiments of the invention embrace attempts to model the status of a technology through modeling data that partially describes aspects about the status/state of the technology, that is, the data features. The technologies under consideration have been identified by name through a manual process of exploration on multiple datasets. The modeling technique may be, for example, an unsupervised classification model, which may be used to model the current year data of the features, and then extrapolate into the future for a prediction. The extrapolation may be any time period, such as 1 year, or less/more than 1 year, for example. The model may output the technologies in classes/groupings, which are compared with the Wardley Maps mapping technique.

The correspondence drawn between the technology groupings and those developed by Wardley Maps shows that an automatic, data-driven approach may be used to predict the state of the technologies under examination in the future. The following sub-sections describe various aspects of some example embodiments.

### A.1 Forecasting of Complex Systems

Forecasting techniques for complex systems is one area of focus. The motivation is to be able to predict how the system of variables and factors can behave and what that system may be like in the future. Most techniques depend on statistical analysis or learning models created to explain the behavior of a select group of data features over time. To be able to make these predictions and forecasts through a data driven approach may be difficult, since almost exponentially more data is required as the complexity of a system increases linearly.

### A.2 Technology Abstraction

Various processes, which may be manual in nature, may be used to retrieve key technology terms from various open-source datasets. In one illustrative example, a set of 32 technology names were aggregated to identify key technologies for consideration, with the aim of establishing some correspondence between the meanings of the technology names so as to best abstract them in as few terms as possible.

### A.3 Feature Selection/Engineering

To use a data driven approach to determine the status of technologies, one must determine what data would be useful and appropriate for the task. To this end, a collection of data features were selected or computed from a group of open-source datasets. These features may act as the primary variables by way of which the ecosystem of technologies may be studied. Various tests may be run on the data of the features to determine the features that are most effective at describing the system. This curated collection of features may then be preprocessed to reach the acceptable form before insertion into the model.

### A.4 Unsupervised Clustering

Some embodiments of the disclosed methodology revolves focus on the usage of the unsupervised-clustering algorithmic approach. A serious issue when trying to model complex systems, like the technology field, is that there may not be a clear indication of what constitutes the true values, which may be referred to herein as ‘ground truth[s],’ against which the generated predictions or forecasts may be compared, and which may be used to evaluate the correctness of the modeling. The unsupervised clustering approach may be especially well suited to addressing problems of that nature as that approach does not require information about the ground truth. Rather, an unsupervised clustering approach may attempt to group data points into distinct classes based on the similarity of the features of the data points. Note that as used herein, ‘unsupervised’ refers to the approach as being automatic exploratory, and not requiring human bias/intervention in the computational process.

Embodiments of the invention may employ various techniques for unsupervised data clustering such as, but not limited to, K-Means and Affinity Propagation (AP) clustering. The K-Means algorithm requires as input the number of unique classes ‘K’ for which it attempts to group the datapoints into. That is, a user may specify that the user would like all the data of a dataset grouped into four clusters, for example. On the other hand AP clustering may operate to determine an optimal number of clusters automatically, but may require the user to provide a hyperparameter for how much tolerance the algorithm should have to distortion in the data-groupings while clustering. A method known as the ‘elbow method’ for estimating the best value for K may be used to determine K for K-Means, and the hyperparameter for Affinity Propagation may be estimated through trial and error.

Clustering may be employed in some use cases by applying the algorithm on the data points, of the select features, collected for the technologies. The best K may then be estimated and then the resulting classification/grouping may be interpreted for qualitative value and insight.

### A.5 Wardley Maps

Example embodiments may employ a mapping technique known as Wardley Maps. This technique aims to explain a system of technologies through constructing different maps that describe aspects relating to the technologies. Various embodiments of the invention explore two of those maps. The first map breaks down the technology into subcomponents and then maps out the evolutionary phase of each of these components. The second map places each of these technologies, as a whole, into an evolutionary phase (e.g., Peace, War, Wonder) so as to help enable identification of which technologies are in their initial phases, and which reached other phases, such as the phase of highly competitive providers.

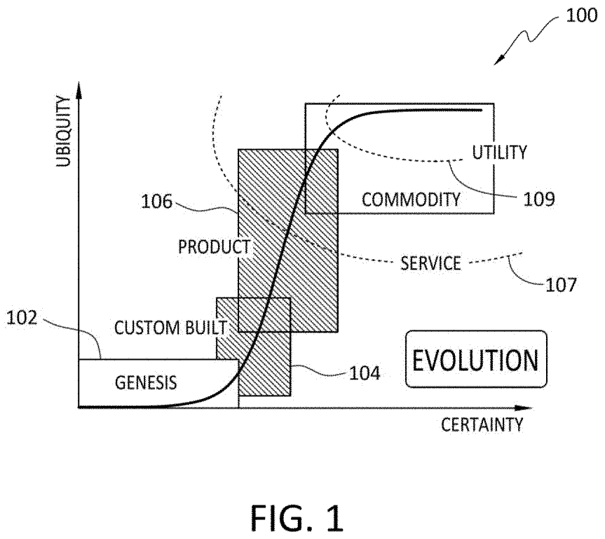

Some embodiments of the invention may employ the 4 phases of technology of the Wardley mapping scheme, which describes a technology as an evolving idea starting at genesis/inception as the first stage and ending at commodity for the final stage. With particular reference to the Wardley Map 100 in FIG. 1, the X-axis indicates increasing certainty as to the viability and usefulness of the technology as the technology matures, and the Y-axis indicates that ubiquity generally increases with technological maturity. That is, relatively mature technologies may be likely to be more widespread in terms of deployment and usage than relatively less mature technologies.

As shown in FIG. 1, a technology may initially be in a genesis phase 102 during which the technology may undergo initial development. In the custom built phase 104, which may follow, and possibly overlap with, the genesis phase 102, the technology may be further developed for specific applications and uses. Next, in the product phase 106, which may follow, and possibly overlap with, the custom built phase 104, the technology has developed to the point where it is deployed in commercial products. Also, at some point in the product phase 106, a point may be reached where the deployed products require servicing and/or upgrades, as shown by the service zone 107. Finally, in the commodity phase 108, which may follow, and possibly overlap with, the product phase 106, the technology has reached technical maturity and may require servicing, but is no longer being upgraded. As well, in the commodity phase 108, the technology may reach a point where it has diminishing utility, as shown by the utility zone 109. Note that the Wardley Map 100 shown in FIG. 1 is presented by way of example, and is not intended to limit the scope of the invention.

### A.6 Clustering Integration with Wardley Maps

The Wardley mapping technique discussed above, and elsewhere herein, may be employed in connection with example embodiments as follows. Initially, unsupervised clustering algorithms may be used to group and cluster the technologies together based on similarities in their feature data. Next, the Wardley ‘phases of technology’ maps may be used to manually check the clustering results against the Wardley mapping techniques.

Then, if a correspondence or similarity is found between the clustering results and Wardley map phases, one could make claims about the current phase/state of the technology. For example, if a technology is grouped with other technologies that are at an early conceptional state of their development life-cycle, that may be a good indication that this technology is at that same development stage as well. Future predictions could be made about the status of the technologies in question by extrapolating the grouping results of the model.

### B. Detailed Description of Some Example Embodiments

In general, some example embodiments may automatically map various technologies to one of the four phases of a Wardley Map, as discussed above in connection with FIG. 1, based on various date sources. Example data sources include, but are not limited to, IEEE (Institute of Electrical and Electronics Engineers) and Google Patent databases. One possible end goal of this automatic mapping technique is to gain insights about the evolution and maturity of a specific technology in order to be used later for strategic planning purposes.

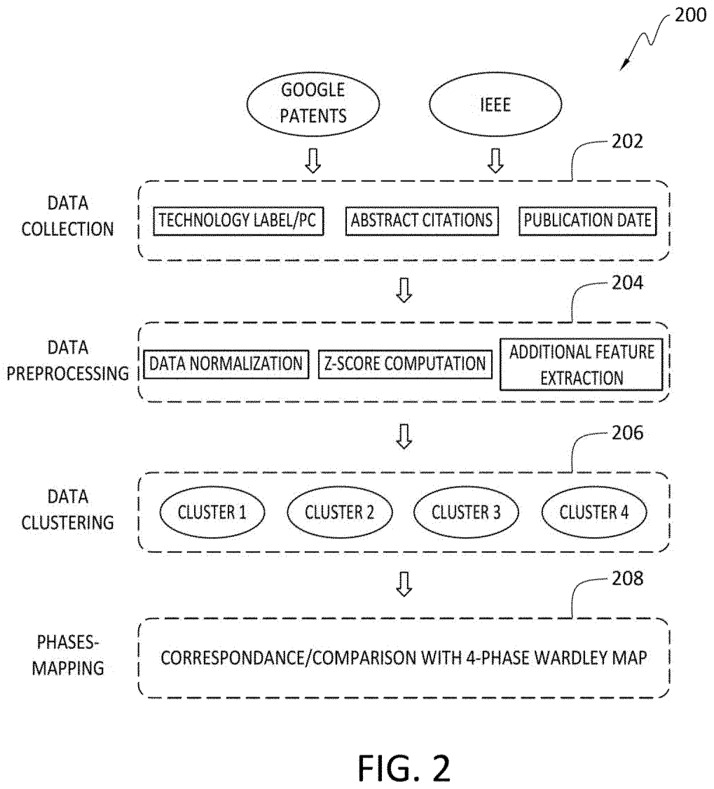

With reference now to FIG. 2, it can be seen that an example mapping process 200 may comprise four stages, namely, data collection 202, data pre-processing and preparation 204, data clustering 206, and phases-mapping 208. In the data collection stage 202, historical metadata may be collected from sources such as the IEEE and Google Patents databases, and/or other open source databases. The historical metadata may contain, for example, patent and research paper information such as abstract, citations, publication date, technological terms and phrases, and technological labels.

At the data pre-processing and preparation stage 204, patents and research papers, and/or other information, may be grouped together according to their technological classes. Important features may then be extracted that describe, for example, the number of publications, and the number of citations per technological class. The features may then be normalized in preparation for the next stage.

At the data clustering stage 206, an unsupervised clustering approach may be implemented on the extracted features using K-Means and/or Affinity Propagation algorithms. Each technology may be mapped to one distinct cluster based on the criteria of the clustering algorithm. Finally, at the phases-mapping stage 208, each cluster of technologies may be mapped to a specific phase, examples of which are disclosed in FIG. 1, that describes the maturity and evolution of each cluster. Further details will now be provided concerning the various stages disclosed in FIG. 2.

### B.1 Data Collection

In order to evaluate the maturity and evolution of a certain technology, various datasets may be employed that reflect the popularity and/or maturity of technologies among a specific audience. Such datasets may include, for example, opensource datasets like Google Trends, IEEE, arXiv, USPTO, and Google Patents, datasets. Additional sources may be employed to obtain information about matters not specifically technological in nature, but which relate to technology. For example, databases such as Google Scholar may be used to identify which types of technology patents are most likely to be the subject of litigation where issues such as patent validity and patent infringement may be addressed. In one example evaluation performed in connection with embodiments of the invention, the IEEE and Google patents datasets were employed.

The IEEE dataset is an opensource rich dataset that contains a significant amounts of metadata about published research papers. The IEEE dataset may enable extraction of data points that contain information per paper about publication date, authors, technology labels, number and dates of citations and abstracts. This information alone may be used to observe the popularity, or ubiquity, of a certain technology among the academic society which may be considered as the starting point of any technology.

The Google Patents dataset is an opensource large dataset that contains a significant amount of information about published patent applications, and issued patents. For each accessible patent and patent application, a variety of metadata may be extracted, such as inventors, assignees, technology labels, USPTO search classes, filing dates, publication dates, issue dates, publication date number, dates of citations, and the full text. Similar to the IEEE dataset, the Google Patents contains a significant amount of information indicating the popularity of a certain technology in the industry. As well, a database such as Google Patents may enable determinations to be made as to, for example, the number of applications filed/published as compared with the number of applications that ultimately issued as a patent.

### B.2 Data Pre-Processing and Preparation

At this stage, features may be extracted that are directly related to the popularity of certain technologies across the IEEE and Google Patents datasets. First, the technologies of interest may be identified in order to better assess and evaluate the methodology. In one illustrative case, a review of trending technologies for the years 2018/2019 across data sources such as IEEE, Google Patents, Gartner Hype Cycle and SimFin (discussed in further detail below), identified the 32 technologies listed in Table 1 below as candidates for further investigation.

TABLE 1

| | | | |
|---|---|---|---|
| 3D printing | Data Processing | Immersive | Next Gen |
| | for Business | Workspaces | Memory |
| | Operations | | |
| 3D Sensing | Data Processing | IOT | Pictorial |
| Cameras | for Computational | | Communications |
| | Models | | |
| Artificial | Data Visualization | Knowledge | Resource |
| Tissues | | Graphs | Allocation |
| Audio Devices | Data Visualization | Machine | Satellite |
| | Based on GUI | Learning | Transmission |
| Autonomous | DigitalOps | Medical Data | Semiconductors |
| Driving | | | |
| Biochips | Explainable AI | Mixed | Telephonic |
| | | Reality | Communication |
| Computational | Flying | Mobile | Transmission |
| Models | Autonomous | Drones | |
| | Vehicles | | |
| Data Privacy | Image Processing | Neural | Wireless |
| and Security | & Generation | Network | communication |
| | | Models | networks |

For technologies listed in Table 1, all the relevant IEEE papers and patents were retrieved and grouped into 32 classes that corresponds to the list of technologies. For each class, 8 features were extracted that describe each class in terms of popularity and state. These features are combined from IEEE and Google patents datasets as discussed below.

### B.2.1 Example Dataset—IEEE Dataset

IEEE Z-Score: The Z-Score was calculated for each class of the 32 classes based on the number of citations of IEEE publications in a given period of time. Z-Score may be an accurate statistic as it may provide useful a metric to describe the bibliometric/citation statistics of the classes invariant of time limitations.

IEEE Citation Count: This feature describes the number of citations per technology or class for a given period of time.

IEEE Count Rate: This feature describes the change in the number of publications per technology or class between two dates. This rate feature may be used as an indicator for the relative popularity of each technology or class.

IEEE Citation Rate: This feature describes the change in the number of citations per technology or class between two dates.

### B.2.2 Example Dataset—Google Patents Dataset

Patents Z-Score: The Z-Score was calculated for each class of the 32 classes based on the number citations of patents in a given period of time. Along with IEEE Z-Score, the Z-Scores may be used to confirm the state of a certain technology in terms of publications and patents.

Patents Citation Count: This feature describes the number of citations per technology or class for a given period of time.

Patents Count Rate: This feature describes the change in the number of patents per technology or class between two dates. This rate feature may be used as an indicator of the relative popularity of each technology or class.

Patents Citation Rate: This feature describes the change in the number of citations per technology or class between two dates.

After retrieving all the aforementioned IEEE and Google Patent features for all of the 32 technologies, the features were normalized across all technologies. In general, normalization may provide a way to make the data more consistent and maintain general distribution and ratios in the source data.

### B.3 Data Clustering

At this stage, the focus turns to attempting to cluster the 32 technologies into groups where the elements of each group exhibit similar characteristics. One goal of the clustering process may be to observe the similarity between these clusters and the Wardley map phases. Clustering may be performed using various techniques, and the scope of the invention is not limited to any particular technique. Two possible approaches to clustering, namely, K-Means clustering, and Affinity Propagation clustering, are discussed below.

### B.3.1 K-Means Data Clustering

K-Means data clustering comprises an unsupervised clustering algorithm that may be used to divide the training data into groups which have not been explicitly labeled. In some instances at least, K-Means data clustering may be used to confirm business assumptions about what types of groups exist, and/or to identify unknown groups in a multivariate dataset. In the illustrative example disclosed herein, K-Means data clustering is used it to provide insight into whether or not the IEEE and Google Patents features are directly related to one of the four phases of the Wardley Map (see FIG. 1).

The K-Means algorithm may begin with a group of randomly selected centroids, which may be used as the respective beginning points for every cluster, and the algorithm may then perform iterative calculations to optimize the positions of the respective centroids. One constraint in this approach is that the number of centroids, or clusters, may have to be specified beforehand, that is, prior to running the K-Means algorithm.

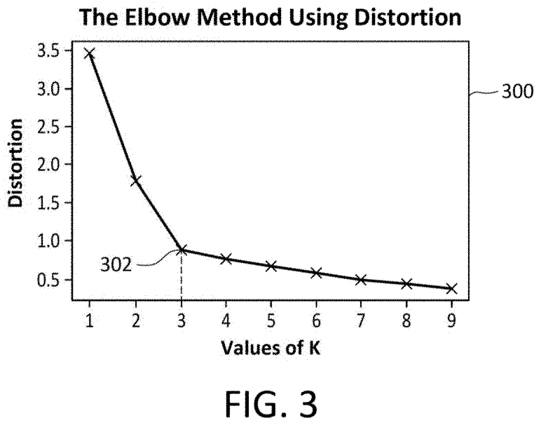

In order to eliminate, or at least reduce, any subjectivity in this automated process, the Elbow method may be used to decide what is the optimal number of clusters for the data that is to be clustered. In general, the Elbow method is based on the fact that increasing the number of clusters enables better modelling of the data. The Elbow method may determine the cutoff point, expressed as a number of clusters, past which the addition of more clusters to the algorithm may not materially enhance the data modelling. FIG. 3 shows a graph 300, where the number of clusters is expressed as K, and K is shown on the X-axis. Distortion of the data is shown on the Y-axis and, in general, tends to decrease as K increases.

In the example of FIG. 3, the elbow 302 is located at K=3. While increasing K values reduce the distortion further, the additional gain in distortion reduction is considerably less for those K values than for the K values up to, and including, the elbow 302 value of 3. After determining the optimal number of clusters (3 in the example of FIG. 3) for the data, the 32 technologies may then be clustered into the different clusters.

### B.3.2 Affinity Propagation Clustering

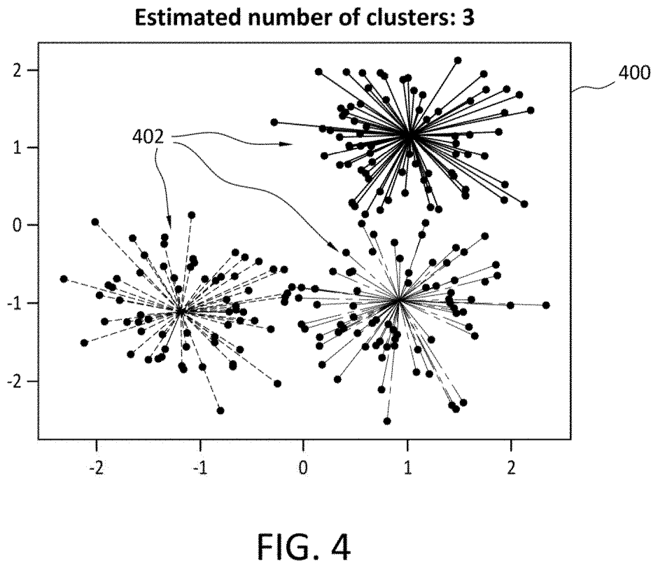

Affinity Propagation is an unsupervised clustering algorithm. Unlike K-Means, Affinity Propagation does not require that the number of clusters be specified. In Affinity Propagation approach, each data point corresponds to a technology and sends messages to all other points or targets informing those targets of their respective relative attractiveness to the sender. Each target then responds to all senders with a reply informing each sender of its availability to associate with the sender, given the attractiveness of the messages that it has received from all other senders. Senders reply to the targets with messages informing each target of the revised relative attractiveness of the target to the sender, given the availability messages that the sender has received from all targets. This message-passing procedure may continue until a consensus is reached. Once a sender is associated with one of its targets, that target becomes the exemplar of that point. All points with the same exemplar may then be placed in the same cluster. This is illustrated in the graph 400 of FIG. 4 which shows the data distributed into three different clusters 402.

### B.4 Phase-Mapping

After the technologies have been grouped into clusters using K-Means or Affinity propagation, the resulting clusters, or groups, may be evaluated and then correlated with one of the phases of a Wardley Map. In order to do this correlation for the first time, a subjective Wardley Map may be constructed for each technology based on surveying various data sources like Gartner Hype Cycle, Google trends, SimFin and other data sources. The role of these constructed maps may be primarily, or only, to provide intuition about the resulting clusters and show confirmation or contradiction signs according to the following process. In particular, that process may involve a first part in which technologies are grouped together based on their current phase in the subjective Wardley Map. These groups may be considered as ground truth groups. In the second part of the process, each of these ground truth groups may be compared with the clustering groups to check if there is an actual correlation between these groups or not.

### C. Some Examples and Results

In order to test and validate the approach disclosed herein, three experiments were conducted. In the first and second experiments, K-Means clustering was employed with 2 different values for K. In the third experiment, Affinity Propagation clustering, which does not require specification of a particular number of clusters in advance, was employed.

For the clustering process, the data to be clustered was extracted from IEEE and Google Patents data for the 32 technologies noted in Table 1, for the timeframe between the years 2018 and 2019. For validation and phases-mapping, a manually constructed Wardley Map for the year 2019 was employed based on a survey of various different data sources.

### C.1 K-Means Clustering

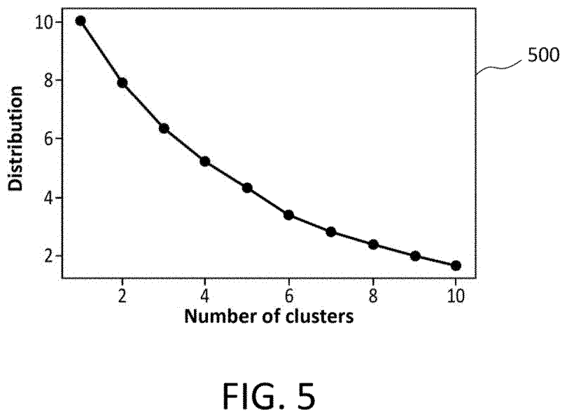

Since the K-Means clustering algorithm requires that the number of clusters be specified beforehand, the Elbow method was employed on the data to determine the optimal number of clusters. As shown in the example graph 500 in FIG. 5, the elbow of the curve lies in the area between K=4 and K=5. Thus, these k values may serve as a starting point for the analysis.

### C.1.1 Experiment 1: 4 Clusters

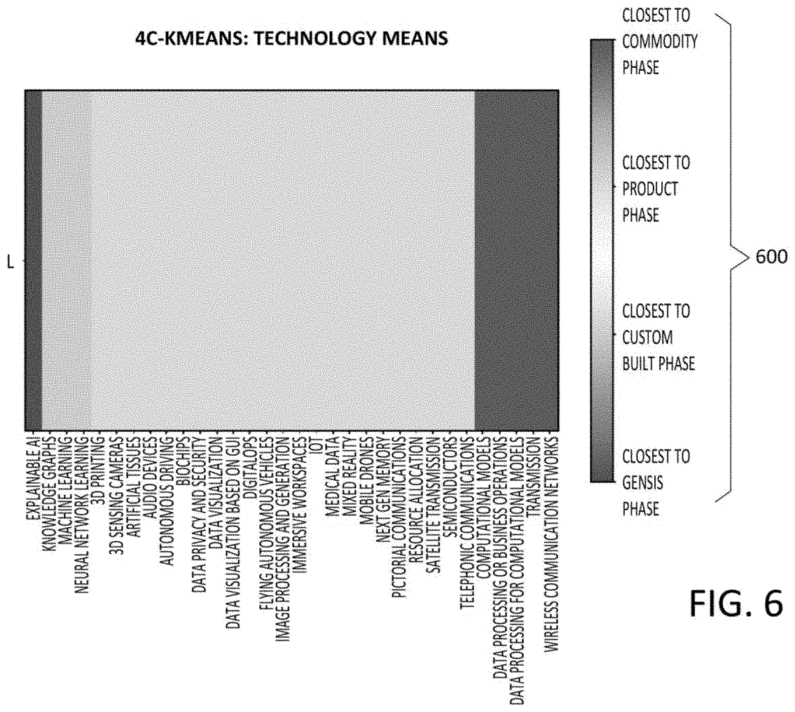

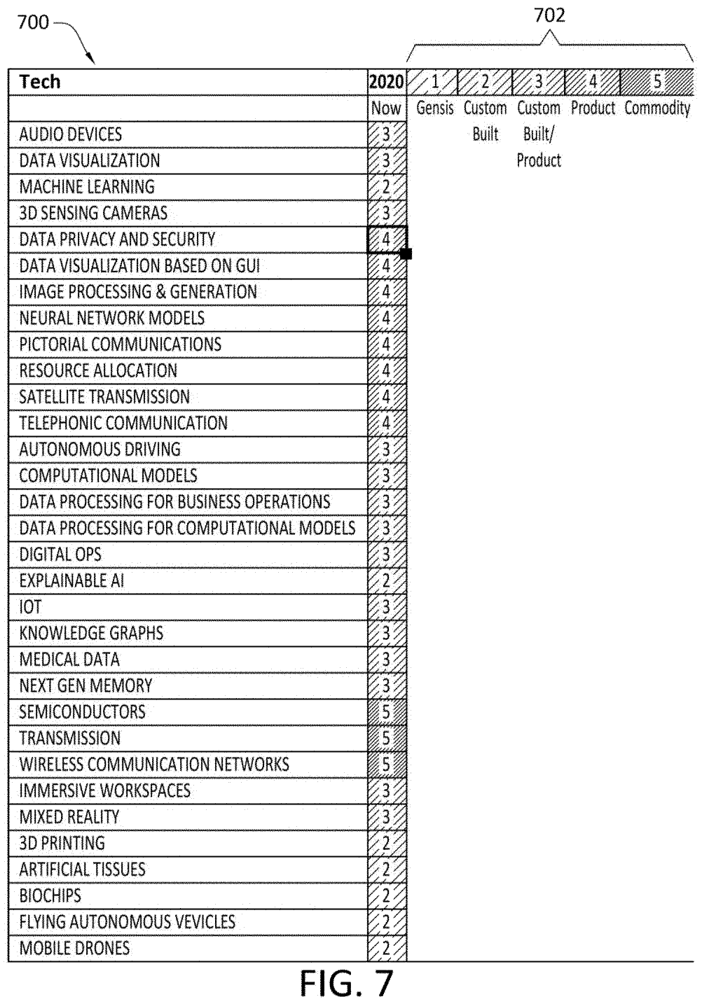

In this experiment, 8 features were extracted for each technology and preprocessed. Application of the K-Means clustering algorithm resulted in the 4 clusters generally denoted at 600 in FIG. 6. Comparing these results with the manually constructed Wardley Map, that is, the ground truth, it can be seen in FIG. 7 that there is a clear correlation between the clusters 700 and the phases 702 of the manual Wardley Map.

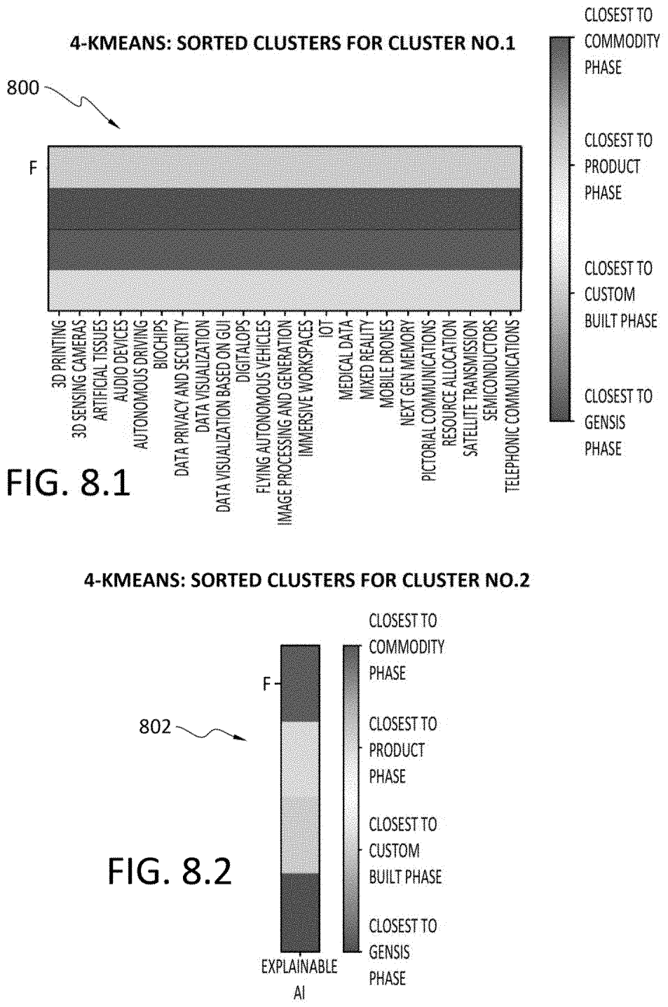

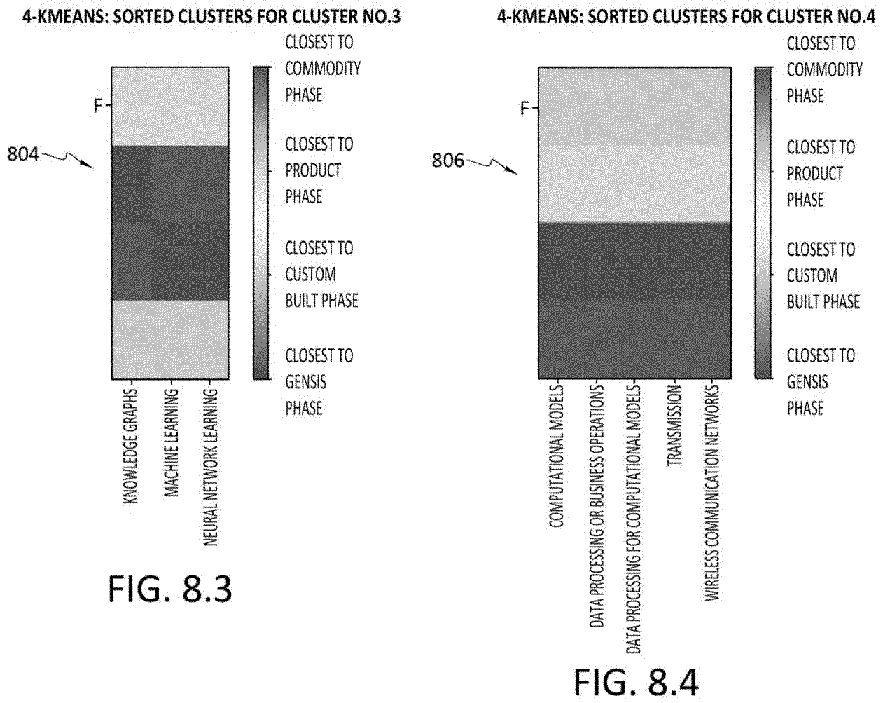

This correlation may be further affirmed by checking similarity between technologies that belongs to a specific cluster and other clusters. For example, for technologies that belong to cluster 1, it is possible to calculate the similarity between these technologies and other clusters, that is, clusters 2, 3, and 4. This similarity may be calculated using Euclidian distance between the technologies of cluster 1 and the centroids of the remaining clusters. This similarity check with other clusters may be used to affirm the correlation between clusters and Wardley map phases. Since Wardley Map phases may follow a certain pattern, that is, genesis, custom, product, commodity and then genesis again, it may be expected that the clusters of the experiment will follow the same pattern. For example, and as indicated in FIGS. 8.1, 8.2, 8.3, and 8.4, technologies of the cluster that corresponds to custom phase should be more similar to technologies of the cluster that corresponds to either genesis phase (precedent phase) or product (later phase). Particularly, the clustering 800 in FIG. 8.1 shows sorted clusters for cluster 1, the clustering 802 in FIG. 8.2 shows sorted clusters for cluster 2, the clustering 804 in FIG. 3 shows sorted clusters for cluster 3, and the clustering 806 in FIG. 8.4 shows sorted clusters for cluster 4.

### C.1.2 Experiment 2: 5 Clusters

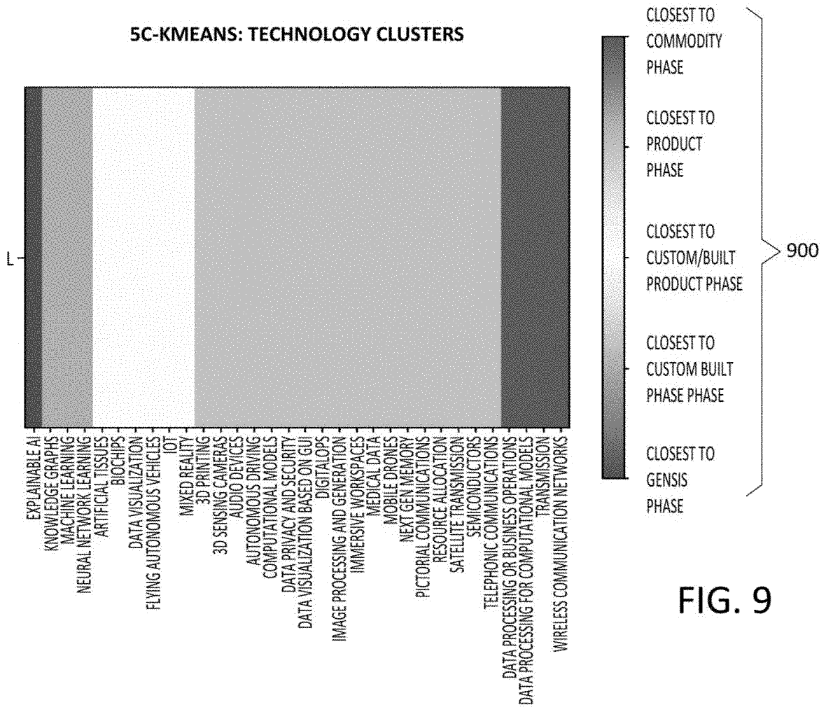

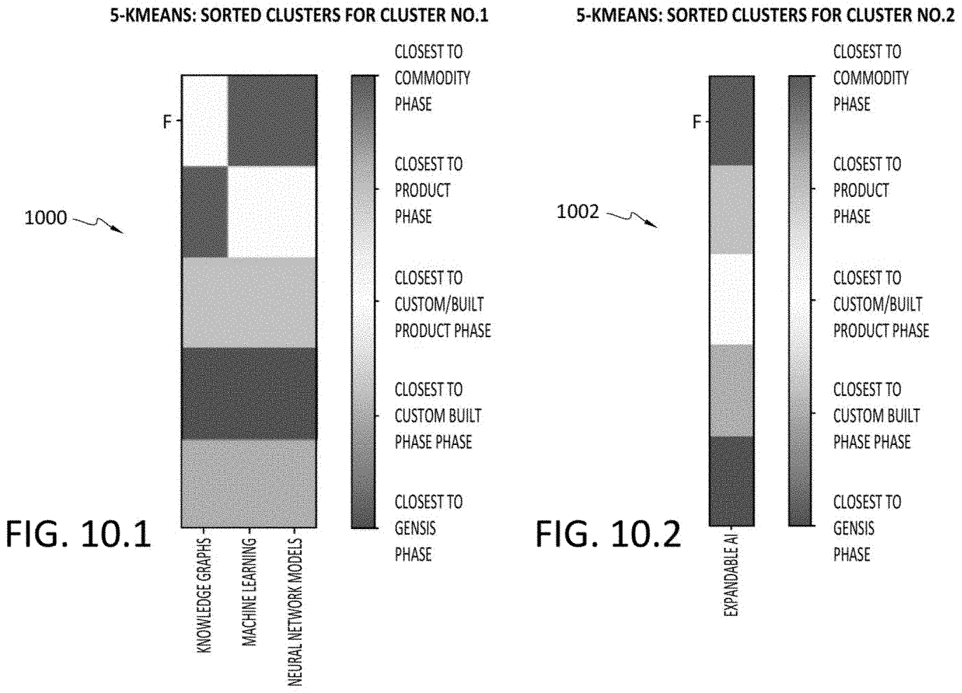

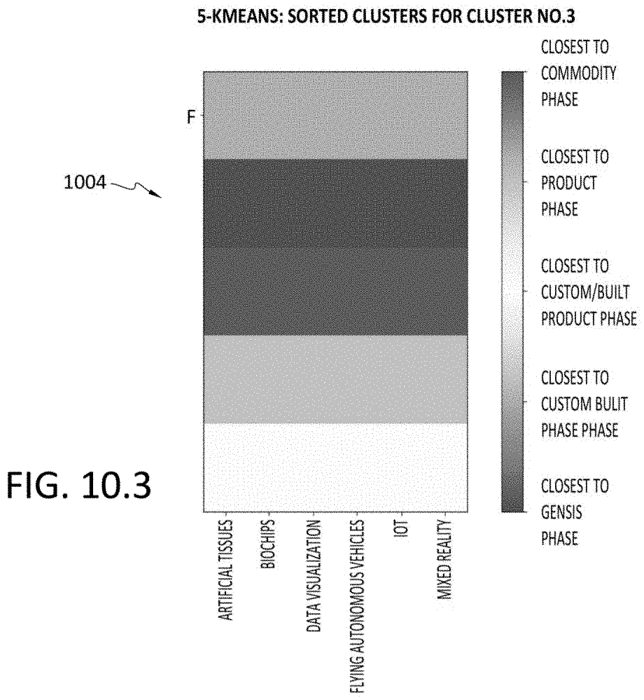

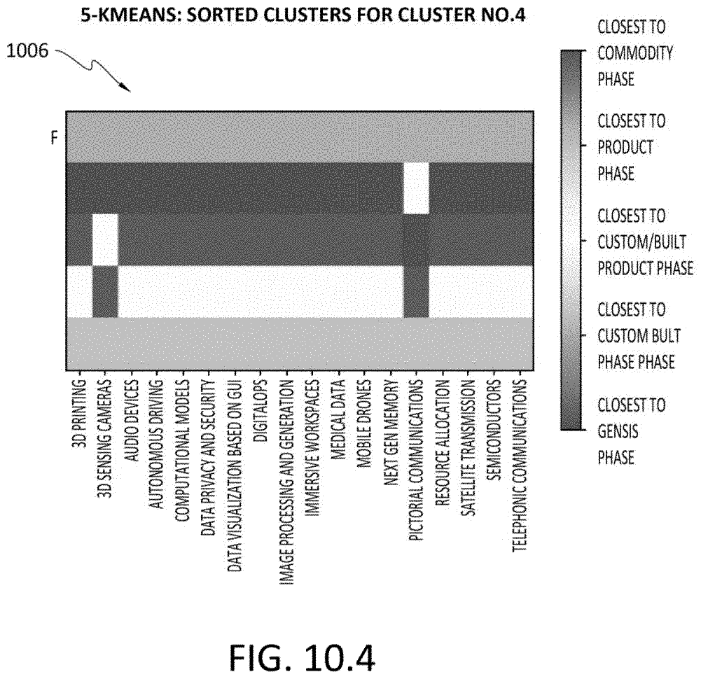

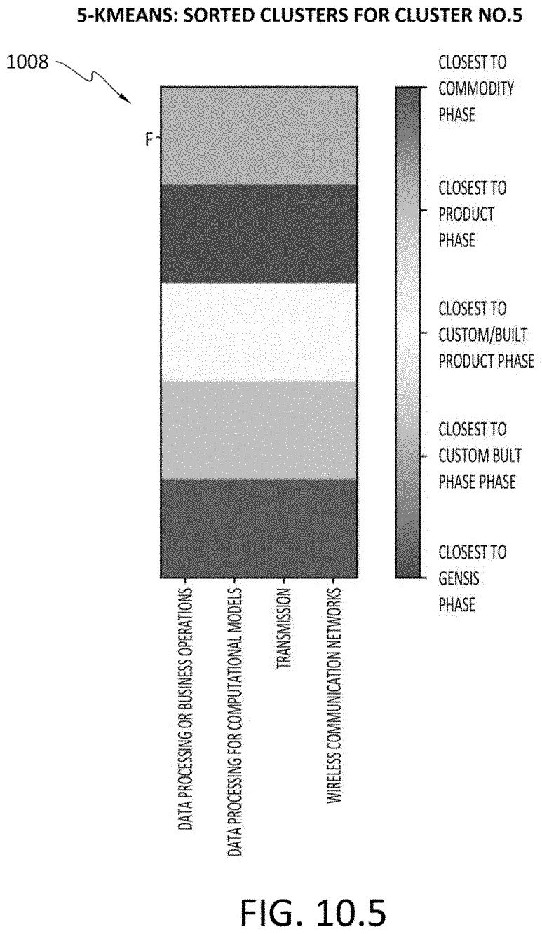

In this experiment, the 8 features for each technology were extracted and preprocessed. Applying the K-Means clustering algorithm to the extracted data resulted in the 5 clusters 900 shown in FIG. 9. Cluster similarities were then calculated in order to determine that the clusters follow a specific pattern as indicated in the examples of FIGS. 10.1, 10.2, 10.3, 10.4, and 10.5.

Particularly, the clustering 1000 in FIG. 10.1 shows sorted clusters for cluster 1, the clustering 1002 in FIG. 10.2 shows sorted clusters for cluster 2, the clustering 1004 in FIG. 10.3 shows sorted clusters for cluster 3, the clustering 1006 in FIG. 10.4 shows sorted clusters for cluster 4, and the clustering 1008 in FIG. 10.5 shows the sorted clusters for cluster 5.

### C.1.3 Experiment 3: Affinity Propagation

As noted above, the experiments 1 and 2 employed the K-means clustering algorithm. A third experiment applied, instead, Affinity Propagation to generate clusters for the extracted features. As shown in FIG. 8, the use of Affinity Propagation resulted in the generation of 8 clusters 1100. Although the number of clusters is different from the number of clusters obtained is used in the K-Means experiments, the clusters obtained using Affinity Propagation are subsets of the K-Means clusters.

### D. Further Discussion

As will be apparent from this disclosure, example embodiments may, but are not required to, implement various useful functionalities. The following examples are illustrative, but are not intended to limit the scope of the invention in any way.

For example, some embodiments of the invention may integrate various concepts to create a methodology framework for forecasting the phase of technologies. Such concepts may include, but are not limited to: utilization of open-source data across multiple datasets and the extraction of vital features; creation of a correspondence between the technological terms in the IEEE and Google Patents dataset to create standardized features; computation and use of the Z-Score metric as one of the model features; usage of an unsupervised clustering algorithm to group the features according to their values; drawing a correspondence between clustered technologies and the 4-phase Wardley map; and using the Wardley/clustering correspondence to predict which phase a technology would fall under in a future time period, such as in the next year for example.

### E. Definitions

Set forth in Table 2 below are various definitions of terms employed in this disclosure. These definitions are not intended to limit the scope of the invention.

TABLE 2

| Term | Definition |
|---|---|
| Technology/ | Refers to names of popular technologies in the |
| technologies | engineering, sciences, and innovation fields. A |
| | technology could be an overarching theme like |
| | “hardware technology” or more specific like “SSD |
| | storage technology” |
| Technology | The process of predicting the state/status of a |
| forecasting | technology in the future. The state/status refers to the |
| | conceptional state/status of the technology in the field |
| Algorithm | A set of instructions that describe how a task is to be |
| | done systematically. Used to refer to famous |
| | methodologies for problem-solving in specific areas |
| Data | Virtually encoded information that can be accessed |
| | and manipulated electronically, mainly through the use |
| | of computer software |
| Dataset | A virtual collection of data that is usually related in |
| | theme, method of collection, or the observed system. |
| | It usually has a similar structure for all its datapoints |
| Feature | Also known as a variable, a parameter, or a factor. In |
| | the context of modeling systems using data, the factors |
| | which the data is describing are called ‘features’ |
| Ground Truth | The real, observed values or data. Data becomes |
| | ‘ground truth’ or ‘truth data’ when used in the context |
| | of predictive models, as opposed to the ‘predicted |
| | data’ which is the product of the model. Ground truth |
| | is used to verify and compare against the output of |
| | predictive models |
| Open-source | A status for data/dataset and ideas that indicates |
| | freedom to collect and use for academic purposes. |
| | Open-source data is one that is provided for free and |
| | accessible by anyone |
| Clustering | The process of grouping items together based on a set |
| | of criteria. Members of the same grouping will have |
| | more of the criteria in common than members |
| | between different groupings |
| Unsupervised | Refers to a process being executed without human |
| | intervention or manual input. In terms of clustering, it |
| | means the actual grouping process is automated and |
| | does not include human bias |
| K-Means | An unsupervised clustering algorithm |
| Affinity | An unsupervised clustering algorithm |
| Propagation | |
| Statistical | Refer to methods of analysis of data that are based on |
| methods | statistical ideas. Statistics here refers to the |
| | mathematical field |
| Learning | Refer to methods of analysis of data that are based on |
| methods | inexact methods of estimation. These methods are |
| | usually used for prediction-oriented use-cases |
| Technology | The state of a technology based on its conceptional |
| phase | maturity relative to the market/field |
| Wardley Maps | Mapping techniques developed by Simon Wardley. |
| | The ‘phases of technology’ map is employed in some |
| | disclosed methodologies |
| System | A collection of factors that are interrelated. The system |
| | of technologies is a collection of key technology terms |
| | identifying technologies targeted for modeling |
| System | Refers to the complexity of the interactions and factors |
| complexity | in a system. The more interactions and factors, the |
| | more complex the system |
| Data | A collection of computational steps to change the |
| preprocessing | format/structure of data for appropriate usage |
| IPC | Stands for International Patent Classification, used by |
| | patent offices to classify the category of the invention |
| Correspondence | The process of drawing a connection between different |
| | ideas, models, or observations. A correspondence |
| | between model results and mapping results is a |
| | relationship between the elements of both sets of |
| | results. |
| Normalization/ | A preprocessing step that converts all data points to |
| normalize | the same standard to prevent incorrect relative-value |
| | interpretation |
| IEEE | Stands for the Institute of Electrical and Electronics |
| | Engineering. This institute provides thousands of |
| | research papers published in many topics that could be |
| | access from their website |
| Google Patents | This is Google's patents datasets which has filings for |
| | patents in the US. It is also free to access online |
| SimFin | Stands for Simplifying Finance, and offers free records |
| | of public US companies that could be accessed online. |
| | Not all records are free |
| Gartner Hype | This is not a dataset, but a grouping of technologies |
| Cycle | constructed by the Gartner company that can be used |
| | for reference when identifying technology keywords |

### F. Example Methods

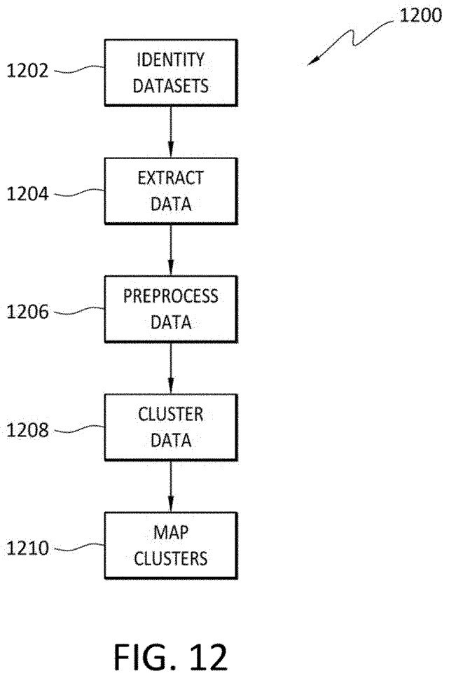

It is noted with respect to the example method of FIG. 12 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Directing attention now to FIG. 12, details are provided concerning methods for generating forecasts and predictions concerning technology lifecycles and phases, where one example method is denoted generally at 1200. The method 1200 may begin with the identification 1202 of datasets that include data expected, or determined, to be relevant to the analysis of one or more technologies. One or more of the datasets may be open source datasets, but that is not necessarily required.

After the dataset(s) have been identified 1202, data needed for the analysis of the technologies may be extracted 1204. The extraction process 1204 may extract data and/or metadata from the identified 1202 datasets. No particular type of extraction process is required to be performed. The extracted data 1204 may comprise information about one or more technologies.

The extracted data may then be preprocessed 1206. Such preprocessing 1206 may comprise, for example, data normalization, Z-score computations, and/or extraction of additional features pertaining to the technologies of interest.

When the data preprocessing 1206 has been completed, the data may then be clustered 1208. The clustering 1208 may comprise application of an unsupervised clustering process to the data. However, no particular clustering process is necessarily required. An output of the clustering process 1208 may be one or more clusters of data where the data in a given cluster may share one or more attributes.

Finally, the data clusters generated from the clustering process 1208 may be mapped 1210. In some embodiments, the mapping process 1210 comprises mapping one or more of the clusters to a respective phase of a Wardley Map. It is possible, though not required, that multiple clusters may be mapped 1210 to the same phase. The outcome of the mapping process 1210 may be the identification of where, in its lifecycle, a particular technology is, where the phases of the Wardley Map each correspond to a respective portion of a technology lifecycle.

### G. Further Example Embodiments

Following are some further example embodiments of the invention. These are presented only by way of example and are not intended to limit the scope of the invention in any way.

Embodiment 1. A method, comprising: identifying datasets known to contain data relating to different technologies; extracting the data from the data sources; performing preprocessing on the data; clustering the data after the data has been preprocessed, and the clustering comprises generating data clusters; and mapping each of the data clusters to a technology lifecycle phase.

Embodiment 2. The method as recited in embodiment 1, wherein clustering the data comprises performing an unsupervised clustering process on the data.

Embodiment 3. The method as recited in embodiment 2, wherein the unsupervised clustering process comprises Affinity Propagation clustering.

Embodiment 4. The method as recited in embodiment 2, wherein the unsupervised clustering process comprises K-Means clustering.

Embodiment 5. The method as recited in embodiment 4, further comprising, prior to performance of the K-Means clustering, specifying a number of data clusters.

Embodiment 6. The method as recited in any of embodiments 1-5, wherein the four phases of the Wardley Map are a genesis phase, a custom built phase, a product phase, and a commodity phase.

Embodiment 7. The method as recited in embodiment 6, wherein one of the phases overlaps with another of the phases.

Embodiment 8. The method as recited in any of embodiments 1-7, wherein the preprocessing comprises any one or more of: data normalization; Z-Score computation; and, additional feature extraction.

Embodiment 9. The method as recited in any of embodiments 1-8, further comprising using the mapping to predict which phase a particular technology would fall under in a future time period.

Embodiment 10. The method as recited in any of embodiments 1-9, wherein the data comprises technological terms, and the method further comprise creating a correspondence between the technological terms in the datasets to create standardized features.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

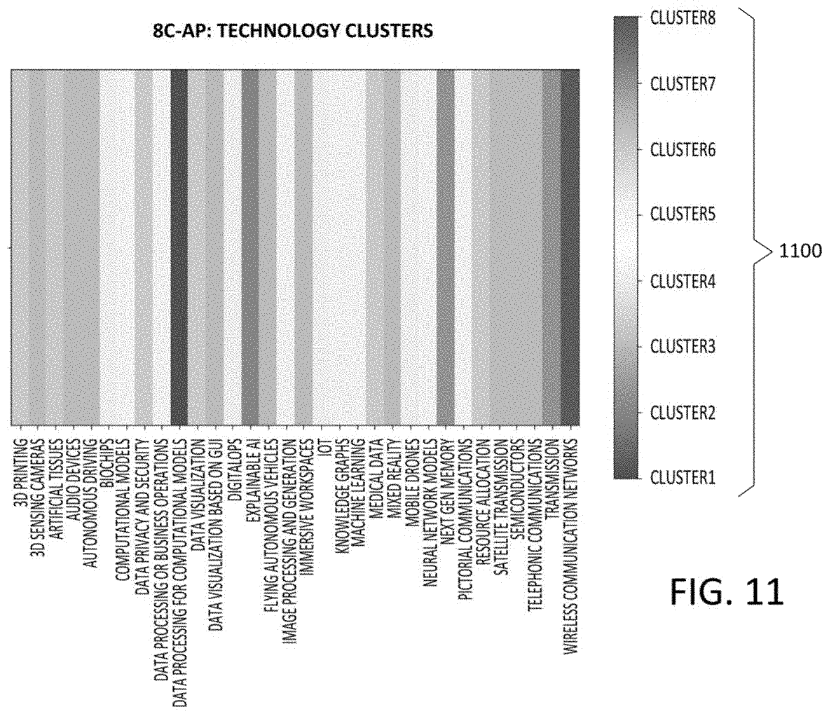

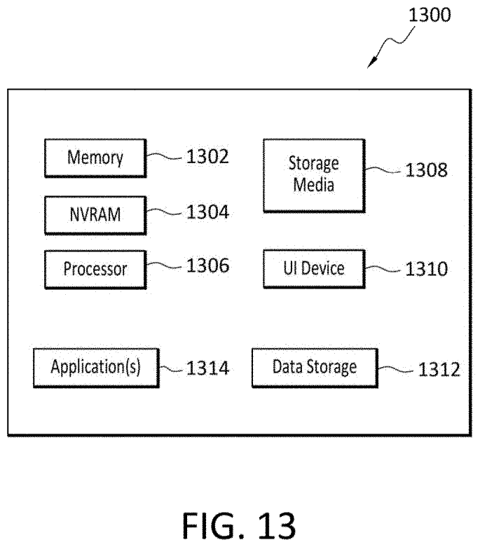

With reference briefly now to FIG. 13, any one or more of the entities disclosed, or implied, by FIGS. 1-12 and/or elsewhere herein, may take the form of, or include, or be implemented on, or hosted by, a physical computing device, one example of which is denoted at 1300. As well, where any of the aforementioned elements comprise or consist of a virtual machine (VM), that VM may constitute a virtualization of any combination of the physical components disclosed in FIG. 13.

In the example of FIG. 13, the physical computing device 1300 includes a memory 1302 which may include one, some, or all, of random access memory (RAM), non-volatile memory (NVM) 1304 such as NVRAM for example, read-only memory (ROM), and persistent memory, one or more hardware processors 1306, non-transitory storage media 1308, UI device 1310, and data storage 1312. One or more of the memory components 1302 of the physical computing device 1300 may take the form of solid state device (SSD) storage. As well, one or more applications 1314 may be provided that comprise instructions executable by one or more hardware processors 1306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
identifying datasets known to contain data relating to different technologies;
extracting the data from the data sources;
performing preprocessing on the data;
clustering the data after the data has been preprocessed, and the clustering comprises generating data clusters; and
mapping each of the data clusters to a technology lifecycle phase.

2. The method as recited in claim 1, wherein clustering the data comprises performing an unsupervised clustering process on the data.

3. The method as recited in claim 2, wherein the unsupervised clustering process comprises Affinity Propagation clustering.

4. The method as recited in claim 2, wherein the unsupervised clustering process comprises K-Means clustering.

5. The method as recited in claim 4, further comprising, prior to performance of the K-Means clustering, specifying a number of data clusters.

6. The method as recited in claim 1, wherein the technology lifecycle phase is one of four phases of a Wardley Map, and the four phases comprise a genesis phase, a custom built phase, a product phase, and a commodity phase.

7. The method as recited in claim 6, wherein one of the phases overlaps with another of the phases.

8. The method as recited in claim 1, wherein the preprocessing comprises any one or more of: data normalization; Z-Score computation; and, additional feature extraction.

9. The method as recited in claim 1, further comprising using the mapping to predict which phase a particular technology would fall under in a future time period.

10. The method as recited in claim 1, wherein the data comprises technological terms, and the method further comprise creating a correspondence between the technological terms in the datasets to create standardized features.

11. A non-transitory storage medium having stored therein instructions that are executable by one or more hardware processors to perform operations comprising:
identifying datasets known to contain data relating to different technologies;
extracting the data from the data sources;
performing preprocessing on the data;
clustering the data after the data has been preprocessed, and the clustering comprises generating data clusters; and
mapping each of the data clusters to a technology lifecycle phase.

12. The non-transitory storage medium as recited in claim 1, wherein clustering the data comprises performing an unsupervised clustering process on the data.

13. The non-transitory storage medium as recited in claim 2, wherein the unsupervised clustering process comprises Affinity Propagation clustering.

14. The non-transitory storage medium as recited in claim 2, wherein the unsupervised clustering process comprises K-Means clustering.

15. The non-transitory storage medium as recited in claim 4, wherein the operations further comprise, prior to performance of the K-Means clustering, specifying a number of data clusters as an input to the K-Means clustering.

16. The non-transitory storage medium as recited in claim 1, wherein the technology lifecycle phase is one of four phases of a Wardley Map, and the four phases comprise a genesis phase, a custom built phase, a product phase, and a commodity phase.

17. The non-transitory storage medium as recited in claim 6, wherein one of the phases overlaps with another of the phases.

18. The non-transitory storage medium as recited in claim 1, wherein the preprocessing comprises any one or more of: data normalization; Z-Score computation; and, additional feature extraction.

19. The non-transitory storage medium as recited in claim 1, wherein the operations further comprise using the mapping to predict which phase a particular technology would fall under in a future time period.

20. The non-transitory storage medium as recited in claim 1, wherein the data comprises technological terms, and the non-transitory storage medium further comprise creating a correspondence between the technological terms in the datasets to create standardized features.
